(19) United States
(12) Patent Application Publication
(10) Pub. No.: US 2018/0225585 A1
(43) Pub. Date: Aug. 9, 2018

(54) SYSTEMS AND METHODS FOR PREDICTION OF OCCUPANCY IN BUILDINGS

(71) Applicant: Board of Regents, The University of Texas System, Austin, TX (US)

(72) Inventors: Bing Dong, Helotes, TX (US); Zhaoxuan Li, San Antonio, TX (US)

(21) Appl. No.: 15/891,739

(22) Filed: Feb. 8, 2018

Related U.S. Application Data
(60) Provisional application No. 62/456,170, filed on Feb. 8, 2017.

(51) Int. Cl. G06N 7/08; G06Q 10/04; G06N 99/00; G06N 3/04; G06N 3/08; G06F 17/16; G06F 17/18

(52) U.S. Cl. CPC G06N 7/08; G06Q 10/04; G06N 99/005; G06Q 50/06; G06N 3/084; G06F 17/16; G06F 17/18; G06N 3/04

(57) ABSTRACT

Disclosed are various embodiments for predicting the occupancy of a space. Measurements of the occupancy of the space can be obtained. A change point can be detected based on the measurements. The occupancy and the number of occupants, if available, of the space for a future interval can be predicted using the data from the change point detected.

### CROSS-REFERENCE TO RELATED APPLICATIONS

This application claims the benefit of U.S. Provisional Application No. 62/456,170, filed Feb. 8, 2017, the entire contents of which is hereby incorporated herein by reference.

### BACKGROUND

Occupancy presence can play a critical role of building operations. Human-building interactions, such as turning on and off the lights, are major disturbances to building management systems. The adjustment of the thermostat alone can drastically reduce heating and cooling energy usage; meanwhile, air conditioning appears in over 91% of newly constructed single family in the US.

According to Energy Star and the U.S. Department of Energy, turning the thermostat down about one degree during heating saves about 2% of total house energy consumption, and the same applies to cooling. Compared to residential buildings, human-building interactions in offices are less varied. The occupants are only offered fewer control options for the indoor environment, such as turning on or off of the light switch, raising or lowering the window blinds, and adjusting thermostats or opening windows, which are all highly correlated to a predictable schedule. It would facilitate reducing energy costs if the occupancy presence in a space could be predicted.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 illustrates an overview of a networked environment according to various example embodiments.

FIG. 2 is pseudocode for a first-order Markov chain a user interface according to various example embodiments.

FIG. 3 illustrates the predictions of occupancy according to various example embodiments.

FIG. 4 illustrates four test houses according to various example embodiments.

FIGS. 5A-D are charts showing the presence rate of the rooms in the four houses (A) ACC, (B) container, (C) SIP, and (D) Stick according to various embodiments of the present disclosure.

FIGS. 6A-D are charts showing the presence rate of the house profile during weekdays in the four houses (A) ACC, (B) container, (C) SIP, and (D) Stick according to various embodiments of the present disclosure.

FIG. 7 is a chart showing change point detection for the moving windows according to various embodiments of the present disclosure.

FIGS. 8A-D are charts showing the presence predictions for 15 minute ahead in 15 minute resolution of the rooms in the four houses (A) ACC house, (B) container, (C) SIP, and (D) Stick according to various embodiments of the present disclosure.

FIGS. 9A-D are charts showing the presence predictions for 30 minute ahead in 30 minute resolution of the rooms in the four houses (A) ACC house, (B) container, (C) SIP, and (D) Stick according to various embodiments of the present disclosure.

FIGS. 10A-D are charts showing the presence predictions for 1 hour ahead in 1 hour resolution of the rooms in the four houses (A) ACC house, (B) container, (C) SIP, and (D) Stick according to various embodiments of the present disclosure.

FIGS. 11A-D are charts showing the presence predictions for 24 hour ahead in 15 minute resolution of the rooms in the four houses (A) ACC house, (B) container, (C) SIP, and (D) Stick according to various embodiments of the present disclosure.

FIGS. 12A-D are charts showing the presence predictions for 24 hour ahead in 1 hour resolution of the rooms in the four houses (A) ACC house, (B) container, (C) SIP, and (D) Stick according to various embodiments of the present disclosure.

FIGS. 13A-D are diagrams illustrating a comparison between models based on modeling levels for (A) Markov Chain, (B) Probability Sampling, (C) ANN, and (D) SVR according to various embodiments of the present disclosure.

FIG. 14 is a schematic block diagram that illustrates an example computing device employed in the networked environment of FIG. 1 according to various embodiments.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

In the following paragraphs, the embodiments are described in further detail by way of example with reference to the attached drawings. In the description, well known components, methods, and/or processing techniques are omitted or briefly described so as not to obscure the embodiments. As used herein, the “present disclosure” refers to any one of the embodiments described herein and any equivalents. Furthermore, reference to various feature(s) of the “present disclosure” is not to suggest that all embodiments must include the referenced feature(s).

Among embodiments, some aspects of the present disclosure are implemented by a computer program executed by one or more processors, as described and illustrated. As would be apparent to one having ordinary skill in the art, the present disclosure may be implemented, at least in part, by computer-readable instructions in various forms, and the present disclosure is not intended to be limiting to a particular set or sequence of instructions executed by the processor.

The embodiments described herein are not limited in application to the details set forth in the following description or illustrated in the drawings. The embodiments discussed herein can be capable of other embodiments and of being practiced or carried out in various ways. Also, the phraseology and terminology used herein is for the purpose of description and should not be regarded as limiting. The use of “including,” “comprising,” or “having” and variations thereof herein is meant to encompass the items listed thereafter, additional items, and equivalents thereof. The terms “connected” and “coupled” are used broadly and encompass both direct and indirect connections and couplings. In addition, the terms “connected” and “coupled” are not limited to electrical, physical, or mechanical connections or couplings. As used herein the terms “machine,” “computer,” “server,” and “work station” are not limited to a device with a single processor, but may encompass multiple devices (e.g., computers) linked in a system, devices with multiple processors, special purpose devices, devices with various peripherals and input and output devices, software acting as a computer or server, and combinations of the above.

Occupant behavior models are necessary for use in controls of the smart buildings. Developing the appropriate algorithm to predict occupancy presence and level of occupants for different building types will allow a better control and optimization of whole building energy consumptions. This disclosure focuses on providing a unique data set of four residential houses collected from occupancy sensors within one year period in the United States. A new inhomogeneous Markov model for occupancy presence prediction is proposed and compared to commonly used models, such as probability sampling, Artificial Neural Network, and Support Vector Regression. Training periods for the presence prediction are optimized based on change-point analysis of historical data. The disclosure further discuses and evaluates the predictive power of the models by various temporal scenarios, including 15-min ahead, 30-min ahead, 1-hour ahead, and 24-hour ahead occupancy presence forecasts. The spatial-level comparison is additionally provided by evaluating the prediction accuracy at both room-level and house-level. The final results show that the proposed Markov model outperform the other methods in terms of an average 5% correctness with 11% maximum difference in one time step ahead forecast of the occupancy presence. In day ahead prediction, not many differences could be observed among the models.

The energy performance of residential buildings, however, largely depends on the uncertainties from the occupants, due to (1) the flexible controls over the indoor climate, (2) the diverse usages of appliances, and (3) the energy-intensive but irregular consumption. Meanwhile, the occupancy presence rather than human-building interactions are more and more relevant to the building energy consumptions, especially when building systems are more automated with sensors for occupancy-based controls. Occupancy presence detection by recording the detailed occupants' number in single-family homes is usually not possible because of privacy issues. Hence, presence models rather than occupant-level models are needed to accurately capture the randomness of occupied periods and changes of occupancy patterns in a residential environment. The occupancy presence model should also be able to be expanded for the occupancy predictions in different temporal resolutions (e.g. 15-min to 24-hour window), spatial scales (e.g. a single person room or multiple people house), and occupant types (e.g. the occupancy presence or the number of occupants).

The shortcomings of current studies on modeling approaches of the occupancy presence are reviewed below. Further, a Markov chain model for predictive control purpose is discussed, and three commonly used modeling tools, which are probability sampling, Artificial Neural Network, and Support Vector Regression models. Next, the results of each model on occupancy presence prediction of four residential houses are shown. Temporal and spatial differences between models' predictive performances are further assessed.

Building energy performance simulations can be based on pre-defined static schedules. With co-simulation platforms, it is possible to replicate relatively realistic occupancy schedules by integrating energy simulation software with stochastic occupancy models. The probability sampling approach is a model to reproduce the stochastic occupancy presence. The presence profile is generated from a sampling process of the fitted distributions from historical data. To estimate patterns behind observations, the data containing information of the movement or presence of occupants are normally collected from multiple rooms of the same space type in one building. Then, the average occupied hour per day, the average vacancy ratio per day, the average departure and arrival time per day, and the standard deviations related to these can be compared and modeled for multiple days in the cross-sectional analysis. A space can include a room, a house, a building, or another space.

In essence, the modeling of this key information using probabilistic distributions is through the cumulative distribution functions (CDFs), describing the first arrival time and the last departure time. Meanwhile, several probability distribution functions (PDFs) are used to fit the intermediate departure time, as well as the intermediate absences for morning, lunch, afternoon, and overtime period. To generate the daily occupancy profile from the fitted CDFs and PDFs, the first arrival time and last departure time are firstly identified using the inverse sampling method. Then, intermediate activities can be determined by comparing the pseudo random number against the intermediate departure PDFs. The durations of the intermediate activities can be obtained by the inverse sampling from the duration PDFs.

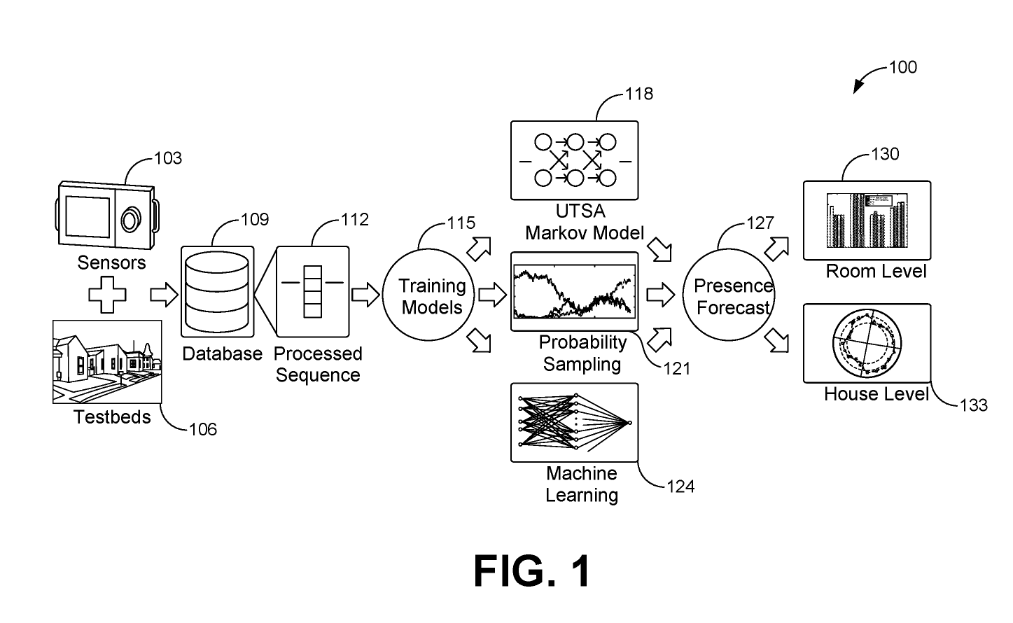

With reference to FIG. 1, shown is a networked environment 100 according to various embodiments of the present disclosure. The networked environment can include one or more sensors 103 in one or more sample environment 106. Measurements from the sensors 103 can be stored in a database 109 including meta data about the measurements. The meta data can include a time of the measurement, a location of the measurement, outdoor temperatures, indoor temperatures, weather conditions, information describing a space including ceiling height, square footage, and other meta data. The data can be processed using a process sequence 112 to generate training models 115. The training models can include a Markov chain model 118, probability sampling 121, and machine learning modules 124. These training models 115 can be used to forecast a presence 127 for a space. The forecast can generate a level for a space, such as, for example, a room level forecast 130 and a house level forecast 133.

The Markov chain model 118 is a stochastic process that can be applied in the occupancy presence modeling. Different modeling algorithms can be explored using both homogeneous and inhomogeneous Markov chains. The Time-User Survey data can be reproduced using the integrated Markov Montel Carlo technique, estimating the transition probabilities of presence and absence by utilizing the inverse function method integrated with inhomogeneous models and generating the occupancy profile using a hierarchical approach that combines homogeneous model with the occupants' movement at different locations of offices. It is also possible to extend the basic structures of Markov models by integrating more sophisticated statistical techniques, such as transforming to a generalized linear model using a logistic from defining the closest distance between two states, or blending the transition matrixes linearly using the approximated coefficients by a slot function.

For all first-order Markov chain models 118, the key assumption is that only previous time-step state infers with current time-step state. However, in a behavior prediction scenario, there may also be a habitual sequence that connects several previous states (behaviors). Some studies using a higher-order Markov model provided preliminary research results on habitual sequence problems. The transitional matrixes were calculated by an integration of the several previous occupancy states that are assumed to contribute to the current transition probabilities. The presence distribution in residential buildings can be generated based on an integration of the discrete histogram from the presence duration. As shown before, a Markov chain of higher order has more complex calculations and non-bimodal characters than a first-order model.

The successful implementation of models can depend on model inputs and model complexity. Endogenous measurements (e.g. CO2) other than the occupancy information required by a specific model (e.g. hybrid Markov chain) could be sufficient in a commercial building environment. However, it is usually difficult and expensive to measure for residential buildings. The theoretical development and computational efficiency of a specific model could limit the usages, such as higher order Markov chain. It normally takes tremendous time and effort to develop the model for one specific scenario. In addition, the majority of the aforementioned models are widely used to generate stochastic daily occupancy profiles as a specific estimation problem for the purpose of building energy performance simulation rather than real-time optimal controls. They are considered to be “validated” if one aspect of the interested information (e.g. mean and variance) of the occupancy estimation is simulated in a statistically reasonable way. In other words, the models match the trajectory between the simulated occupancy profiles and the monitored data in terms of the average arriving time, the average occupied number of the occupants, and the average departure time. They are not evaluated by an exact “one-to-one” correspondence of the predicted occupancy profile to the ground truth at each time step, which is important in the advanced control application, such as ventilation control of an occupied space.

Given the current state of the art, a systematic approach is described for short-term predictions of the occupancy profile of residential buildings for specific advanced control purpose. Here, “short-term” means within 24-hrs ahead of prediction or less. Specifically, a Markov process model is discussed below. The process model can include a modified probability sampling method and two machine learning methods. Occupancy presence data from different residential houses can be collected in 5-min intervals. The data log for motion sensors entails a sequence of times stamped from the presence (value of 1) to the absence (values of 0). A low pass filter can be utilized to generate a time series data in 15-min, 30-min and 1-hour intervals for different prediction window. The occupancy model, developed upon these data, can be designed to deliver the necessary inputs for the predictive controls of the built environment. In the following description, the form of the inhomogeneous chain is explained.

The Markov process, developed for building simulation tools or other building applications, can be used in a discrete form with fixed time steps. The modeling of the chain does not necessarily need to correlate the state of the occupancy with the parameters of the building environment (e.g. indoor air temperature). The endogenous information collected from motion sensors or any other information source in regard to occupancy (e.g. survey data) can be used as inputs. The key assumption to use the first-order Markov chain is that only the instant previous state has the influence on the present state of the occupant (called Markovian property).

Let a Markov chain X at time step k be a sequence containing variables x₁, x₂, . . . , xₖ and the observed set of occupancy states is S={s₁, s₂, . . . , sₙ} where n≤k. The chance of the chain to move from the state sᵢ to the state sⱼ at time step k+1 is decided by the transitional probability defined as:

Pₖ^{ij}=p(xₖ₊₁=sⱼ|xₖ=sᵢ) (1)

Where p(xₖ₊₁=sⱼ|x₁,x₂ . . . , xₖ)=p(xₖ₊₁=sⱼ|xₖ).

Usually, time inhomogeneity implies changes in the underlying probability of the transition between the same pair of the states as time goes on:

p(xₖ₊₁=sⱼ|xₖ=sᵢ)≠p(xₖ=sⱼ|xₖ₋₁=sᵢ) (2)

The transition probabilities between states for more than one step are more easily calculated by a transition matrix. Let P=(pₖ)_{i,j} denote the matrix where each element at index (i, j) represents the probability defined in Equation 1. Suppose that the probabilities are fixed when they are not influenced by any other factors in the current time step, the transitional matrix is defined as:

$$P = {( {p}_{ij} )}_{n \times n} = [ \begin{matrix}{p}_{00} & {p}_{01} & Λ & {p}_{0 n} \\ {p}_{10} & {p}_{11} & K & {p}_{1 n} \\ M & M & & M \\ {p}_{n 0} & {p}_{n 1} & Λ & {p}_{nn}\end{matrix} ] \qquad ( 3 )$$

### Where

$${\sum }_{j = 1}^{n} {p}_{ij} = 1$$

for any 0≤i≤n.

The transition matrix trained for the Markov chain in this study uses the maximum likelihood estimation (MLE) in a moving window optimization. In essence, the moving window is a trimmed window covering the sequence W=({xₜ, xₜ₊₁, . . . , xₛ} in the Markov chain X where 0≤t<s≤k for the prediction of state xₛ₊₁. Given one moving window where there are nᵢⱼ pairs of the states' sequence {sᵢ,sⱼ} in the all pairs of the sequences {sᵢ,sₗ} for t≤l≤s, the transition probability estimated by MLE is:

$${\hat{p}}_{ij} = \frac{{n}_{ij} + α}{{\sum }_{l = 1}^{k} ( {n}_{il} + α )} \qquad ( 4 )$$

Where a is a smooth factor (0<α<0.1). Owing to the limitation of the window size, the occupancy may enter a “sink” state with an extremely small probability of transition. The smooth factor is used to avoid the “sink” state to appear in the stages of estimations.

Integration of the moving-window strategy is proposed to estimate the transitional probability and utilize the model for prediction with a change-point analysis. Two problems, among others, address 1) at which time step should be the horizon of the moving window change and 2) how long should the historical data be chosen in one horizon of the window. Let D={d₁, . . . , d_{24×z}} represent the selectable historical data before the state that needs to be predicted. Here, if the occupancy presence state to be predicted is in a working day, the selection of D only contains the available profiles of z working days. Regardless of the occupancy level, D is processed into a data set containing only the presence and absence as 1 and 0. A discrete profile of the presence probability in daily scale is generated by:

$${P}_{m} = \frac{{\sum }_{j = 1}^{z} ( {λ}^{z - j} \cdot {d}_{( j - 1 ) \times 24 + m} )}{z} \qquad ( 5 )$$

where 1≤m≤24 if the occupancy data is in hourly scale and λ is an exponential forgetting factor, which is below 1. Without forgetting effect, the data of the tested period exerts equal but ever-decreasing influence on the distribution of the presence. An exponential forgetting could maximize penalties on the older information and allow the present probability to retain the most recent information only.

Change point detection can be implemented to check at which time an occupancy presence distribution in a daily profile of the set D is changed. The assumption can be made that a change of the moving window should happen based on the change of presence distribution on a daily scale. The detection algorithm used can include relative density-ration estimation with the Pearson divergence as a divergence measure to score the possible change points. For a subsample m selected from the distribution n, the symmetrized divergence score can be defined as follows:

$$\int {{p}_{α} ( m ) [ \frac{p ( n )}{{p}_{α} ( m )} - 1 ]}^{2} d ( m ) + \int {p ( n ) [ \frac{{p}_{α} ( m )}{p ( n )} - 1 ]}^{2} d ( n ) \qquad ( 6 )$$

where p_{α}(m) αp(n)+(1−α)p(m), p is the probability density function of the corresponding variables, and the factor α is a smooth factor to the plain density ration.

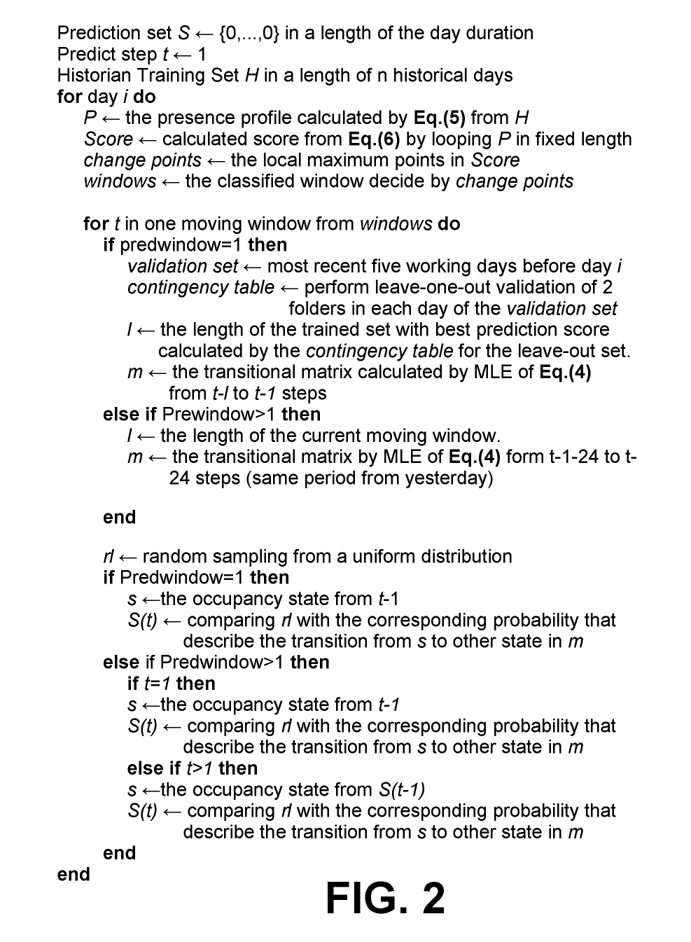

Four main patterns can be extracted and recognized from occupancy presence data: long absence, low presence rate, high presence rate, and long presence. These patterns can be attributed to each of the classified windows. During prediction, each of the state in the next day after the set D is assumed to have the same changing points that are estimated from the presence distribution of the set D. The tuning of the training data as an answer to the second question in a moving window depends on the prediction horizon. In an extremely short-term forecast case, models are commonly trained within one moving window (e.g. 15-min, 30-min, and 1-hour ahead cases). The size of the window can be determined by a contingency table with a leave-one-out validation. The validation can be performed on two subsets of data in five most recent working days. A commonly used 10-folder validation is not suitable in this case due to the limited length of window size. Each tuning length within the horizon can be assigned a score that adds the true positive value and true negative value from the contingency table. The highest score represents a suitable candidate of the tuning length of one moving horizon. In day-ahead prediction, there is no possibility to access the intraday information to calibrate the inhomogeneity; hence, the assumption can be that two consecutive days have similarity patterns. The predictions can thus be simulated in a daily scale where the full horizon of each moving window classified by Eq. (6) is used as the tuning length in that moving window. A more detailed algorithm to predict the occupancy is shown in FIG. 2.

This approach applies the random sampling process on the data by assuming that it does not have the Markov properties. Currently, the probability sampling method can be validated to a certain level to predict the states of the presence. The methodologies adopted can be designed for office environments to predict the occupancy presence in the residential samples.

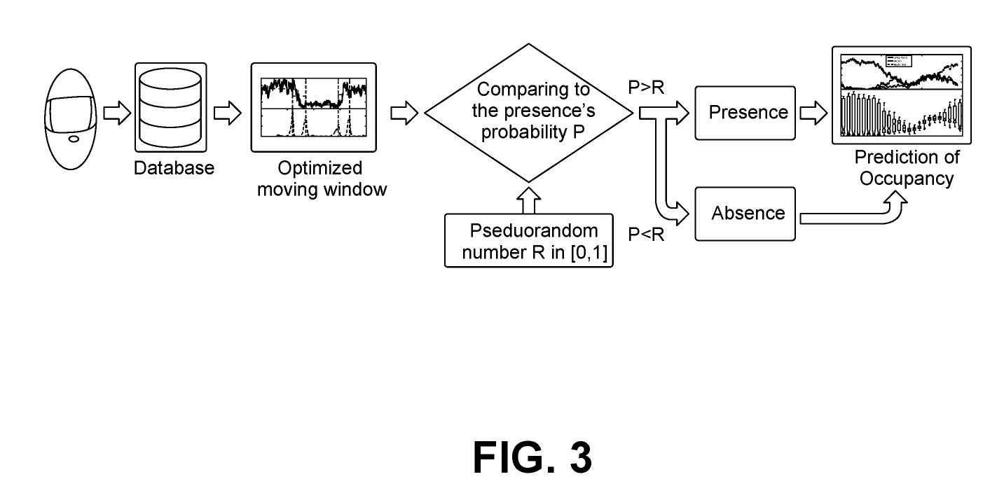

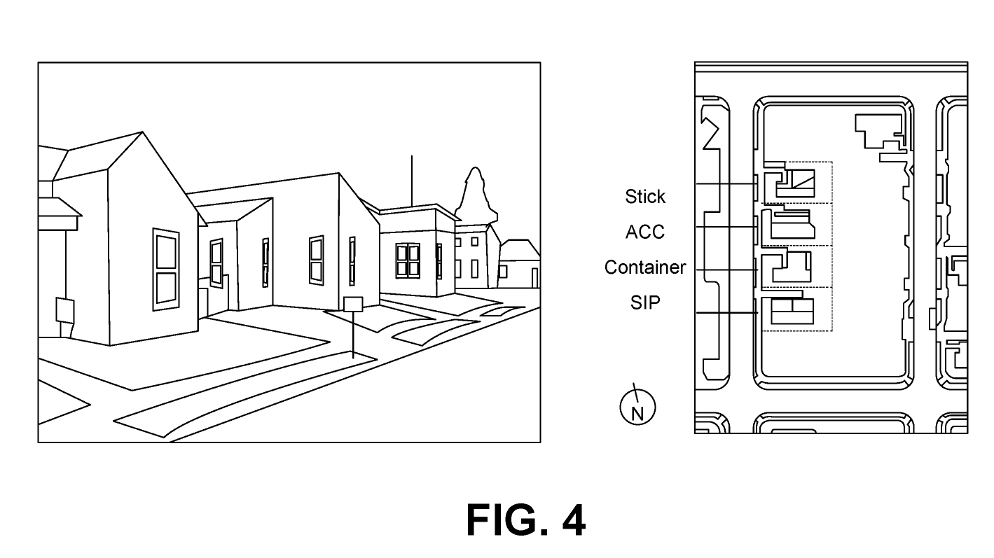

The model can be developed based on the probability profile of the historical presence using inverse sampling during the presence periods. The occupancy states can be categorized based on the sample types. The simulation algorithm only depends on the profile of the presence probabilities generated by Eq. (5). For each time step of the day to be predicted, the occupancy state can be decided by comparing the presence probability at that time step from the profile with a random number drawn from the uniform distribution. The room can be considered to be occupied only if the number is smaller than the presence probability. The algorithm to predict the presence using the random sampling is shown in FIG. 3.

Machine learning is a black box approach. It can be compared to the “white” model, such as the stochastic model, where each probability can be interpreted by the occupancy presence rate. However, the machine learning is characterized as the most versatile tool in the pattern recognition without knowledge of the system. It utilizes advanced computational learning algorithms in the artificial intelligence domain to learn everything from data.

Artificial Neural Network (ANN) and Support Vector Regression (SVR) are discussed as methods of machine learning used in the discussed models. For ANN, feed forward neural network (FFNN) of a single layer and a double layer configuration are discussed. However, due to the over-fitting problem, good forecasts were not found from the double hidden layer structure. Neurons can calculate the weights sum of the inputs and produce the output by transfer functions expressed as follows:

$$f ( x ) = {\sum }_{j = 1}^{N} {w}_{j} {φ}_{j} [ {\sum }_{i = 1}^{M} {w}_{ij} {x}_{i} + {w}_{io} ] + {w}_{jo} \qquad ( 7 )$$

where w is the weights for input, hidden, and output layers, x is the training input, N represents the total number of hidden neurons, M represents the total number of inputs, and ϕ represents the transfer function for each hidden neuron. In this paper, FFNN is modeled as 1 hidden layer with 20 neurons, 1 output neuron (the prediction of presence state), and multiple input neurons (several time lagged values of historical occupancy states depending on the forecasting window). The transfer functions can be the hyperbolic tangent sigmoid functions for the input layer, and the linear transfer function for the output layer. Hidden layer weights in Equation (7) can be learned from Levenberg-Marquardt back-propagation algorithm. Model validation can be performed on a holdout set of the data using the criteria of the mean squared error, where the training set contains at most 70% of the input set.

For support vector regression (SVR), the data can be transformed into a high dimensional space. Predictions can be discriminated from training data as a “tube” enclosed with a desired pattern curve with certain tolerances. The support vectors are the points which mark the margins of the tube. The SVR approximates the inputs and outputs using the following form.

f(x)=wφ(x)+b (8)

where φ(x) represents the transfer function mapping the input data to the high dimensional feature spaces. Parameters W and b are estimated by minimizing the regularized risk function:

$$min \frac{1}{2} {w}^{T} \cdot w + C {\sum }_{i = 1}^{n} ( {ξ}_{i} + {ξ}_{i}^{*} ) \\ s . t . {y}_{i} - {w}^{T} ϕ ( {x}_{i} ) - b \leq ɛ + {ξ}_{i} \\ {w}^{T} ϕ ( {x}_{i} ) - b - {y}_{j} \leq ɛ + {ξ}_{i}^{*} \qquad ( 9 )$$

where n represents the total number of training samples, ξ is the error slacks guaranteeing the solutions, C is the regularized penalty, and ε defines the desired tolerance range of the “tube”. A radial basis function of 3 degrees is used. The SVR model can be relatively insensitive to the value of ε smaller than 0.01 whereas other parameters necessitate independent tuning. These parameters can be determined by 10-fold cross-validation based on mean square error. The grid search scale can be maintained among the range from 10³ to 10⁻³.

The training process of the two methods can be facilitated by testing different configurations of the inputs from the historical presence information. The input set for the 15-min, 30-min and 1-hour ahead windows, defined as H1, can be a Markov order 4 sequence:

H1:f(Oₜ₋₁,Oₜ₋₂, . . . ,O₁₄) (10)

where Oₜ₋₁ represents the occupancy presence from the previous one time step back, . . . , and Oₜ₋₄ represents the occupancy presence from the previous four time steps back.

Input set H2 can be used to forecast the next 24-hour ahead occupancy presence of the current time step Oₜ:

H2:f(Oₜ₋₂₄,Oₜ₋₄₈,Oₜ₋₇₂, . . . ,Oₜ₋₁₆₈ (11)

For one-time step ahead forecast (the 15-min, the 30-min and 1 hour ahead forecast), inputs can include the historical occupancy presence from 1 to 4 time steps back. By comparison, 24-hour ahead cases need the historical occupancy at the same time from yesterday, the day before yesterday, . . . , and the day before one week. These features are selected based on an exhaustive search by minimizing the coefficient of determination.

In one example study, the occupancy data was collected from four houses in downtown San Antonio. The four samples are single-family dwelling around 110 m2 each. Houses are named according to the following construction materials: SIP (Structure Insulated Panel), ACC (Autoclaved Aerated Concrete), Container (Ship Container), and Stick (Wood). The houses are leased and operated mostly by part-time workers and low-income people. The presences of occupancy were monitored at 5-min intervals from over 30 sensors for all the rooms including kitchen, bathroom, living and bedroom areas during the year of 2014. The occupancy detection sensors were Passive Infrared Sensors manufactured by an HOBO system. Sensors were attached under the ceiling of each room. Monitoring data was stored in the memories of each sensor. The sensing ranges were designed to cover all the room areas. All the collected data was further exported to SQL database.

To process 5-minute data to bigger time interval, presence counts can be processed using moving average filters of Savitzky-Golay algorithm, such as, for example, in Matlab. According to one example, the following testing period is selected: ACC's occupancy was modeled from September 17th to October 31st, Container was modeled from May 21st to July 31st, SIP was modeled from January 1st to April 30th, and Stick was modeled from January 1st to March 31st. In one example, all the periods exclude weekends, so only weekdays are used to test the models.

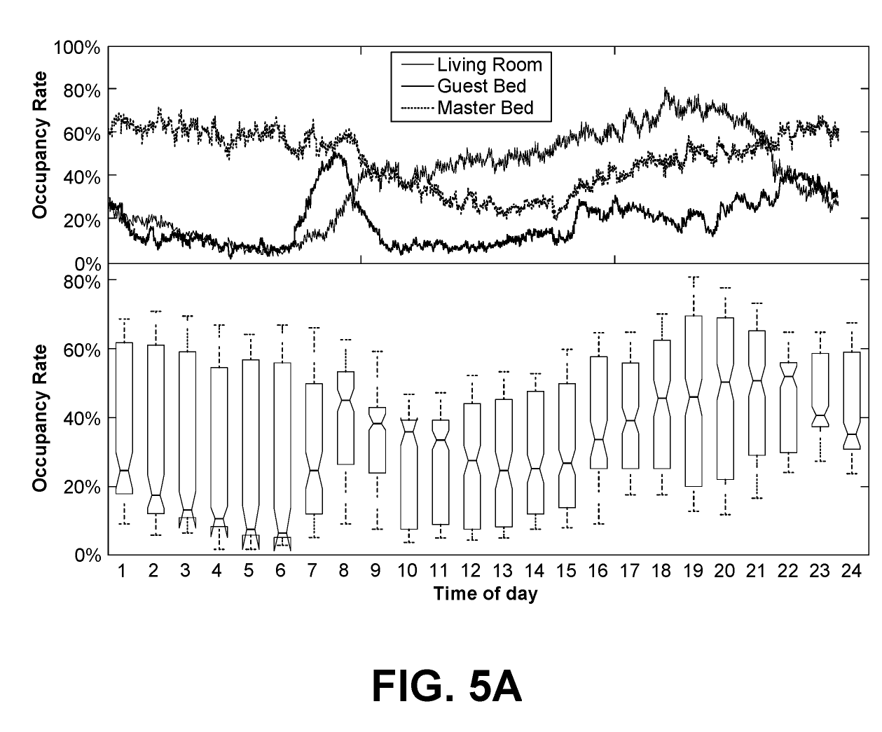

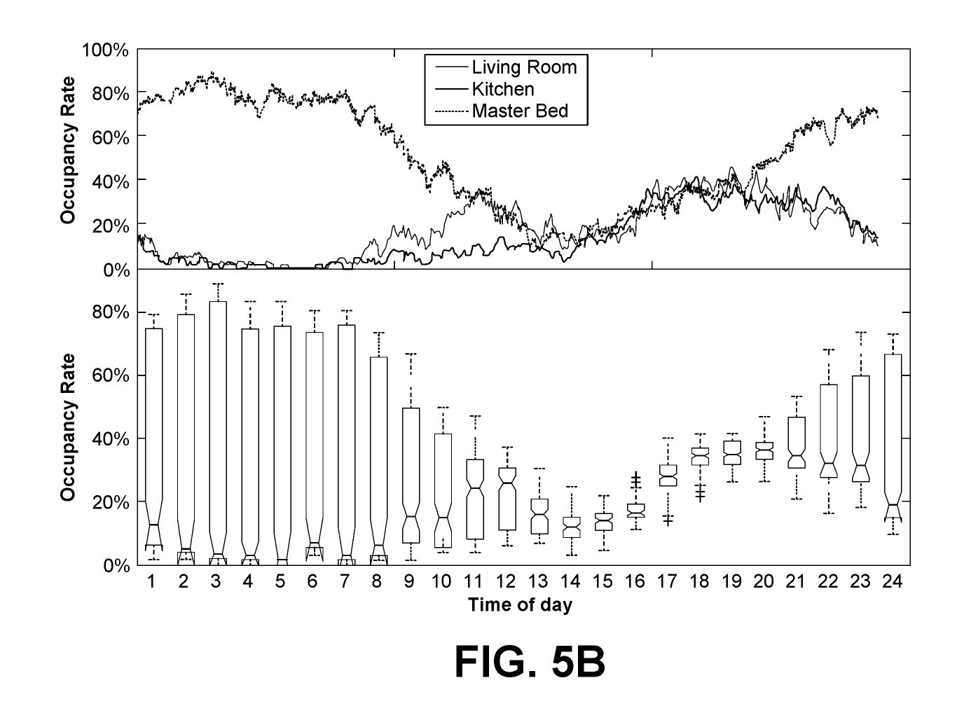

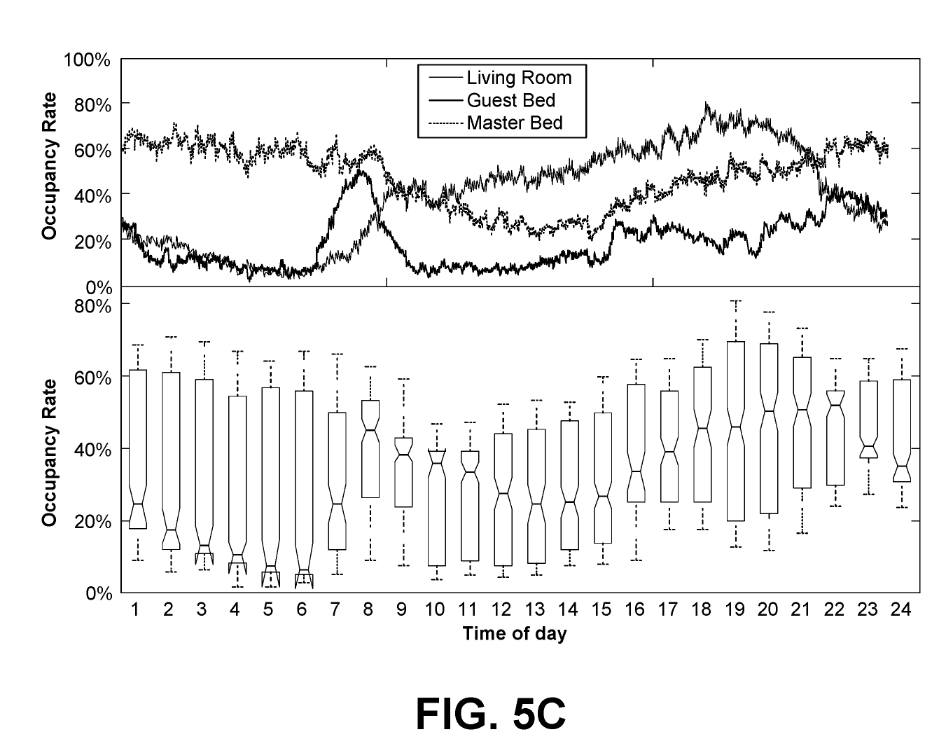

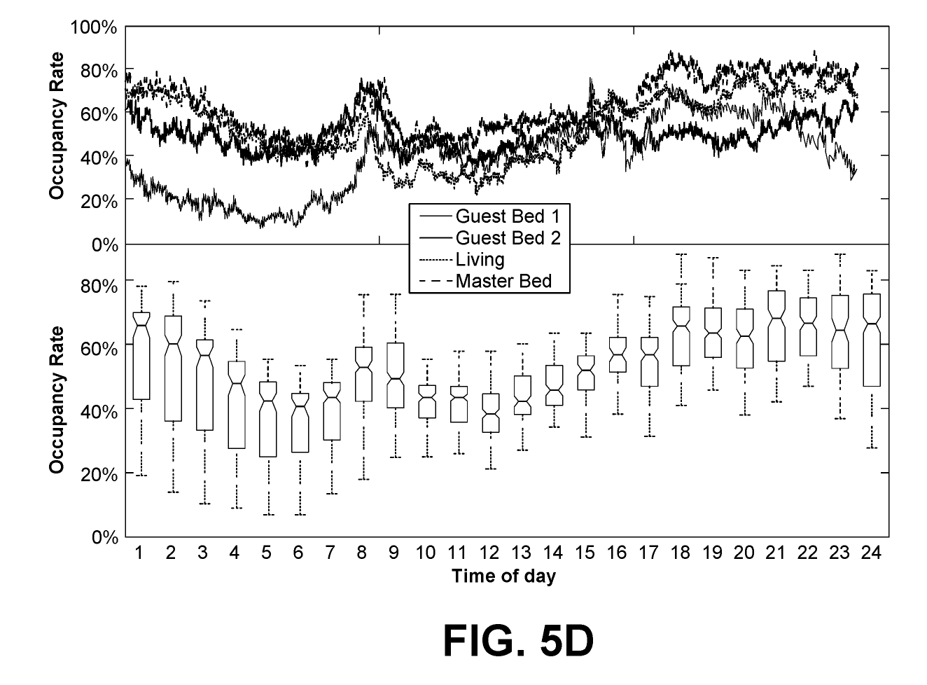

The average rate of the presence can be plotted for the monitored rooms of the four samples, shown in the upper part of each figure in FIGS. 5A-D. All four houses demonstrate striking differences of presence at the room level. However, the common pattern of presence is revealed for individual rooms in a cross-sectional comparison. Master bedrooms are mostly occupied during the night. Living rooms or kitchens are occupied mostly around afternoons and evenings. The variances from all rooms' presence rate in the individual house are presented in the lower part of each figure in FIGS. 5A-D using 1.5 interquartile range (99% confidence interval) in box-and-whisker plots. Each box contains all presence information from n rooms for a period of m working days. For example, if n=3 and m=60, there are in total 180 data points in the one-time slot of the box-and-whisker plot. Large variances are observed in first three houses while the fourth one has a very similar presence patterns.

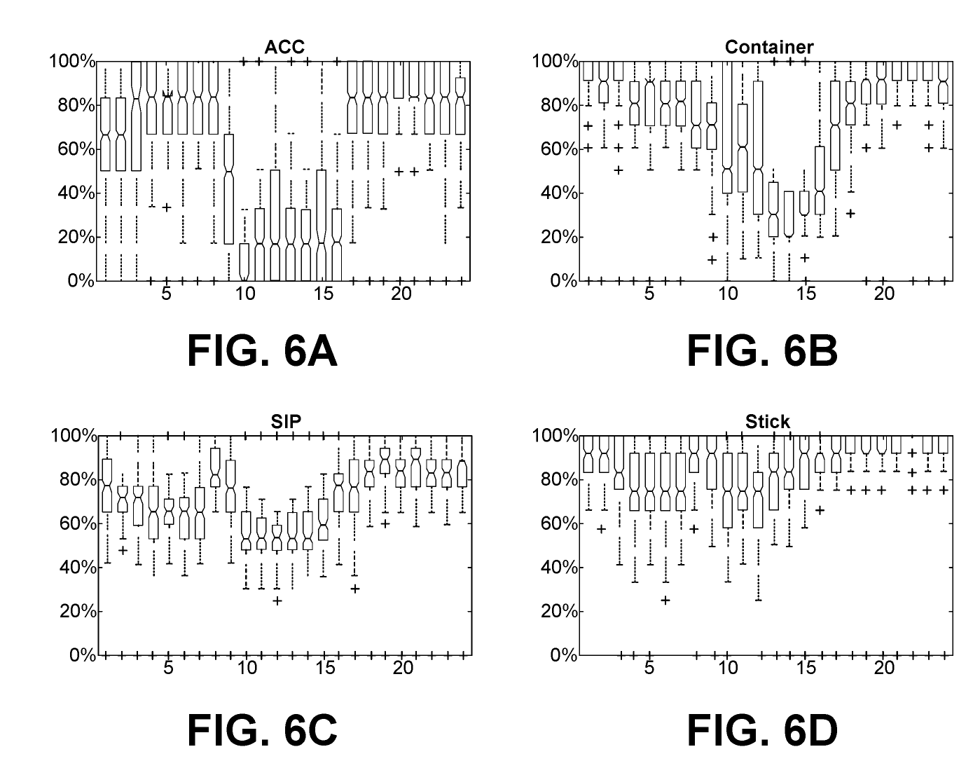

Further analyses reveal the consistence in presence patterns at house level, as shown in FIGS. 6A-D, based on the working days. Each box contains presence information for the whole house for a period of m working days. For example, if m=60, there are in total 60 data points in the one-time slot of the box-and-whisker plot. It shows that until 10 am, most of the residents in the houses (except SIP) have the presence probabilities close to 100% of sleeping, where there are large variances of occupancy presence during the daytime. The ACC's occupant has a probability of 70% to leave the house between 10 am to 4 pm and come back after 5 pm. A more gradual ramp-up and ramp-down is observed in Container house between 10 am to 6 pm. SIP's resident is a part-time worker who works or leaves during the night explaining the lack of presence during the night while Stick's family has a full-time job, explaining the high occupancy during the daytime.

It is also noticed that the variances of the presence rate at the house level in FIGS. 6A-D is significantly smaller compared to those at the room level in FIGS. 5A-D. In room level, lower presence rates are also observed with maximum probabilities around 80%, meanwhile presence rates near 100% are mostly observed during the night time at the house level. This is because at room level, it represents the data variance of all rooms, while at the house level, it is aggregated results of all rooms. Based on these analyses, two assumptions are made for modeling this specific data set: 1) for each day from working days in FIGS. 6A-D, less variance (mostly below 20%) is observed and thus training does not need to differentiate individual day types such as Monday or Friday; 2) the modeling from the house level rather than the room level will be acceptable for occupancy presence forecast if they maintain the similar prediction accuracy, since house-level modeling has lower computation cost and modeling complexity.

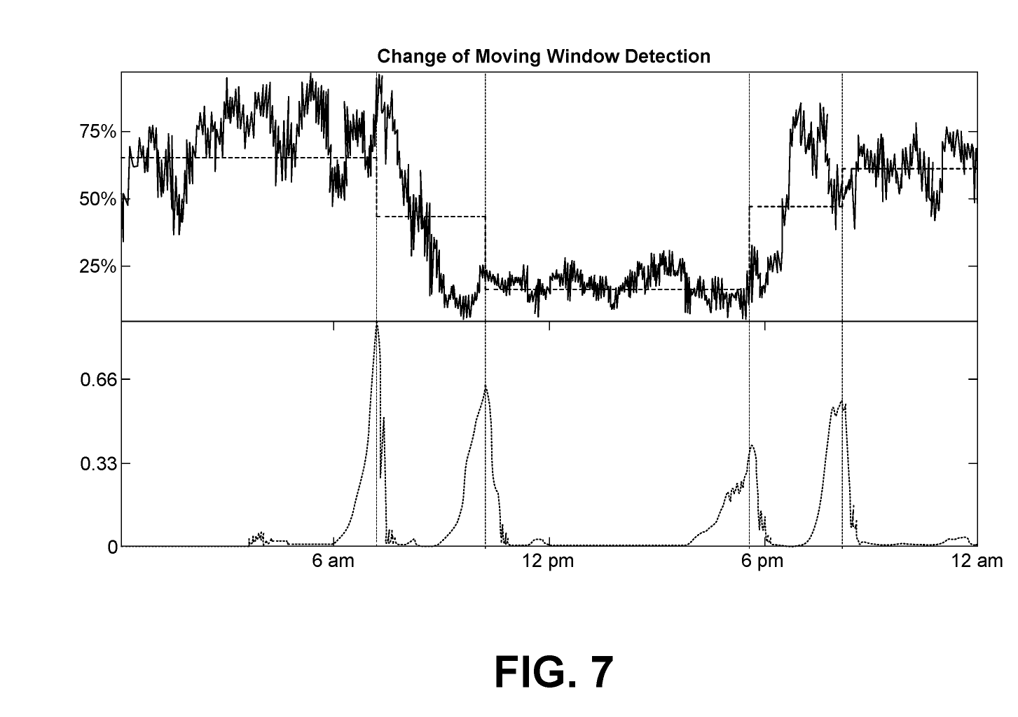

A key to utilizing the stochastic models can depend on the optimization of the moving window. One example of the changing points between the windows is shown in FIG. 7 for the prediction of ACC's master room on October 15th. The normalized score is calculated based on 0.8 forgetting factor with a span of all the historical records before the date. Based on the analysis of historical data, there should be five windows for prediction of that specific day, including one from 12 a.m. to 7 a.m., the next one to end around 10 a.m., the third one to end around 6 p.m., the fourth one to end around 8 p.m., and the last one to end at midnight. All the predictions using the inhomogeneous Markov chain and the probability sampling follow this change rule of the window.

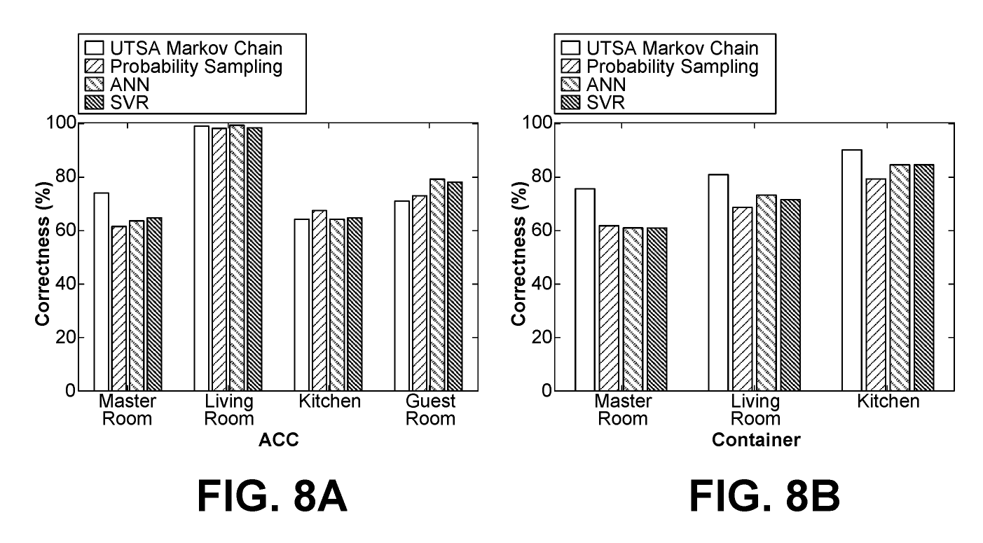

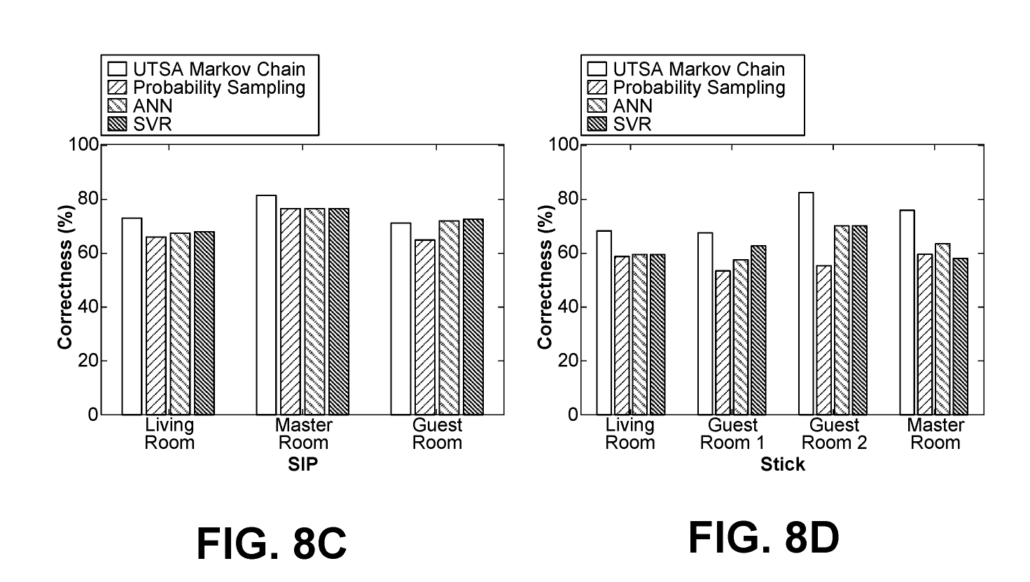

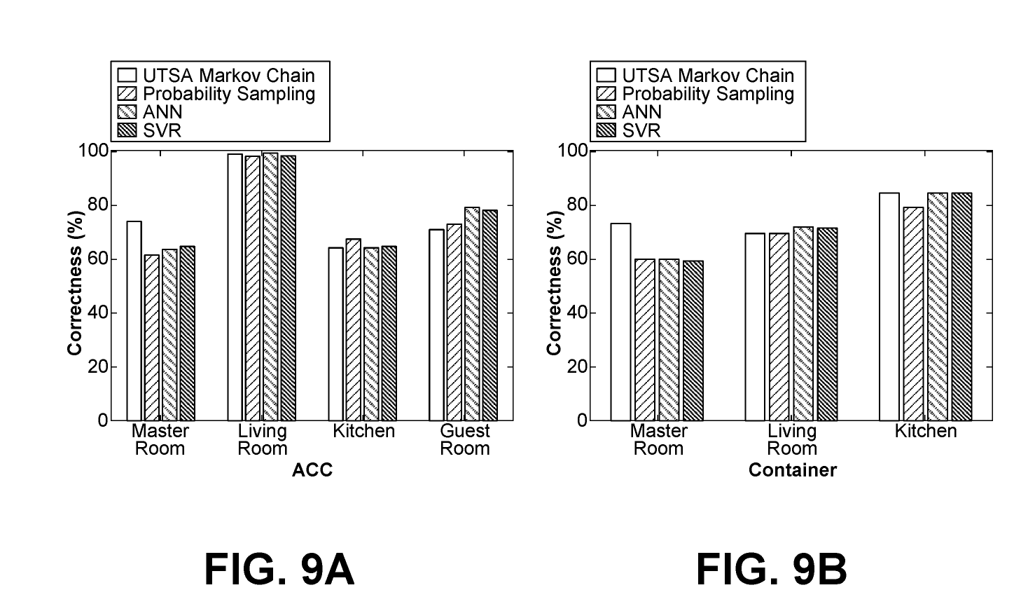

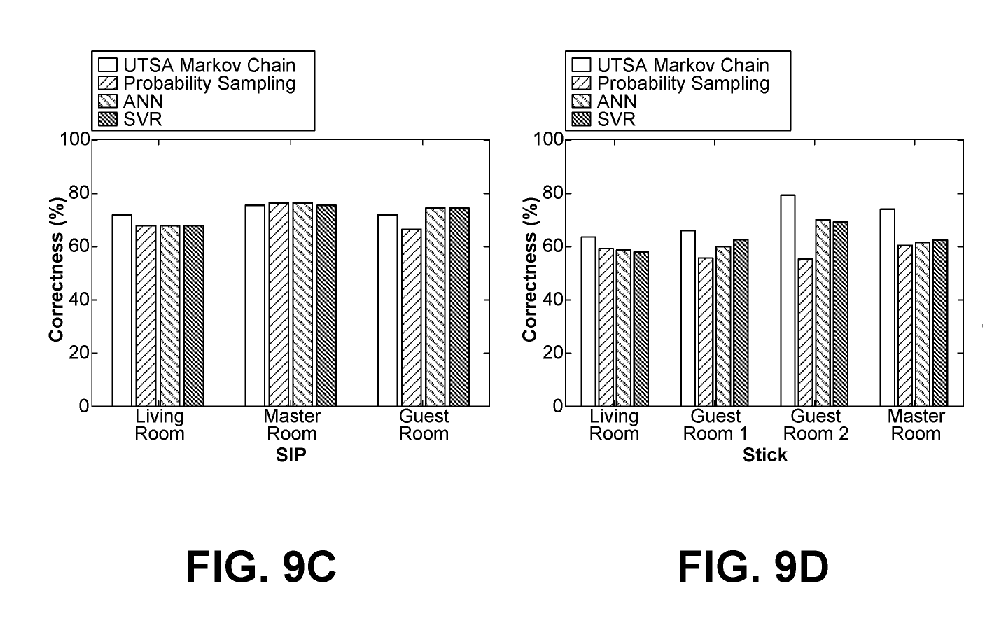

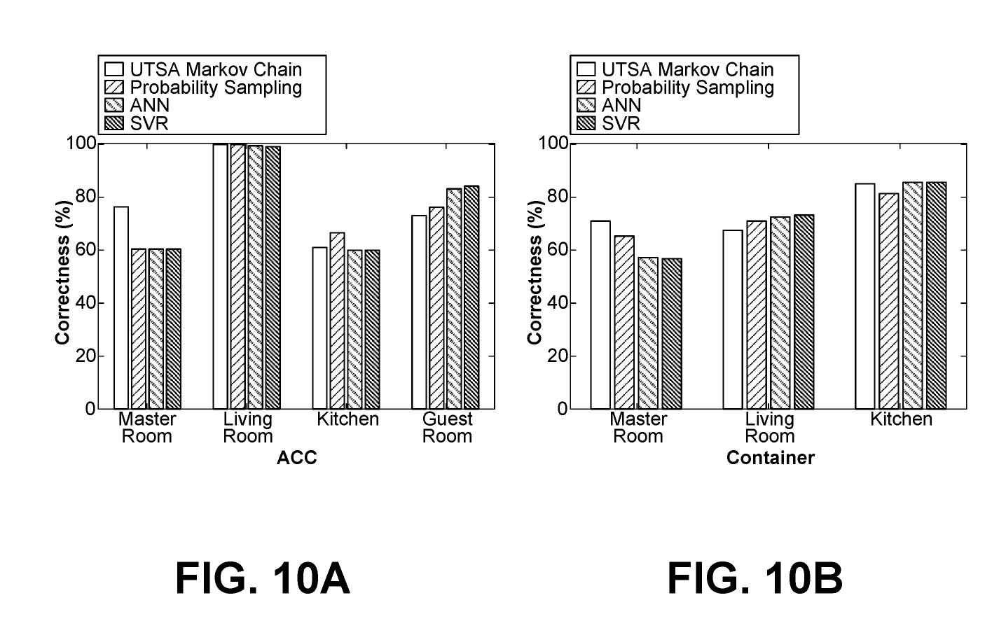

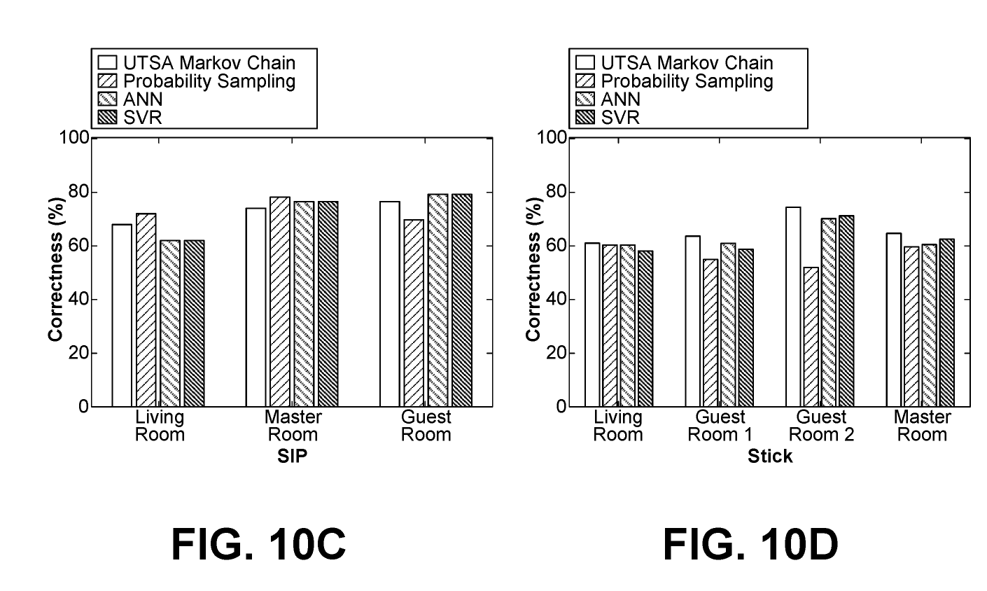

The predictive performance of the models can be evaluated based on the correctness of the occupancy predictions in terms of the occupied and unoccupied states. In one embodiment, there are only two predicted classes, presence and absence. Of the total l predictions, if there are m predicted presence while the observations of the rooms are occupied and n predicted absence while the observations of the rooms are not occupied, the overall accuracy is thus calculated as a percentage, 100×(m+n)/l. All results of the stochastic models' predictions for the individual rooms are presented in FIGS. 8-11 for 15-min ahead, 30-min ahead, 1-hour ahead, and 24-hour ahead respectively.

Compared the plots with FIGS. 5A-D, the presence can be more accurately predicted (>75%) in the extremely short-term forecast (e.g. 15-min till 1-hour) for the Markov model if the presence rate is smooth enough. For example, the presence rate of Container compared to other samples does not have the small spikes observed consistently on the curve. The predictive power of the model is also correlated with the variances. The examples are the living room of ACC (blue line) in FIG. 5A) and the guest bed 2 of Stick (red line) in FIG. 5D). The living room may be a special case owing to the extremely low presence rate (<20%), which represents an absence dominated pattern. In contrast, the guest bed 2 with a persistent presence (between 40% to 60%) can be interpreted as a stationary type of the occupant, in which the resident leaves or enters their room with a regular schedule. A case that can be seen as combined with reasonable smoothness and variance is the guest room of SIP (red line) in FIG. 5C) that still can reach 80% accuracy, where the only big variance is observed between 6 a.m. to 9 a.m. which is a summit up to 50%.

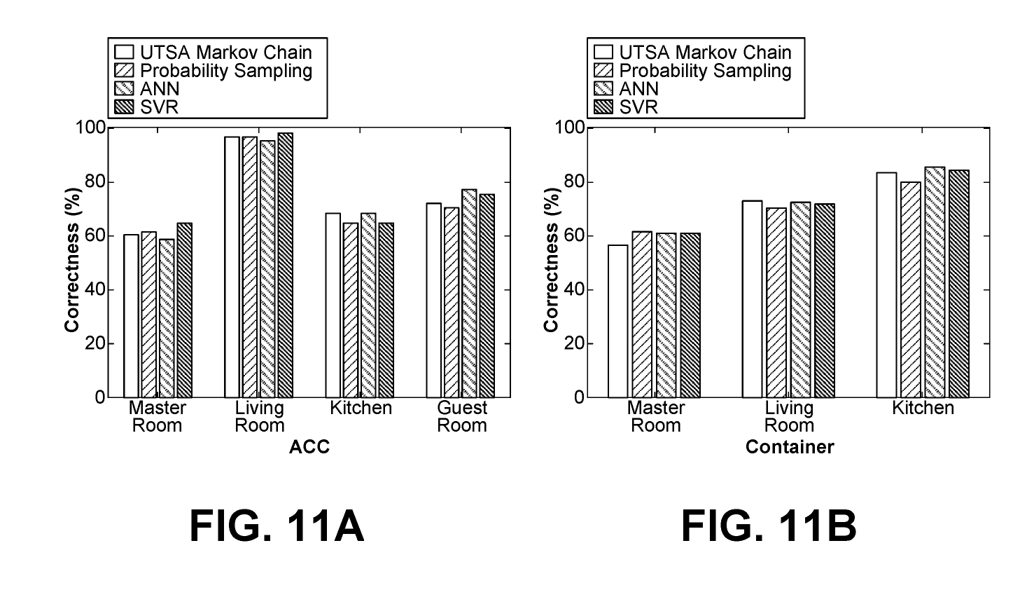

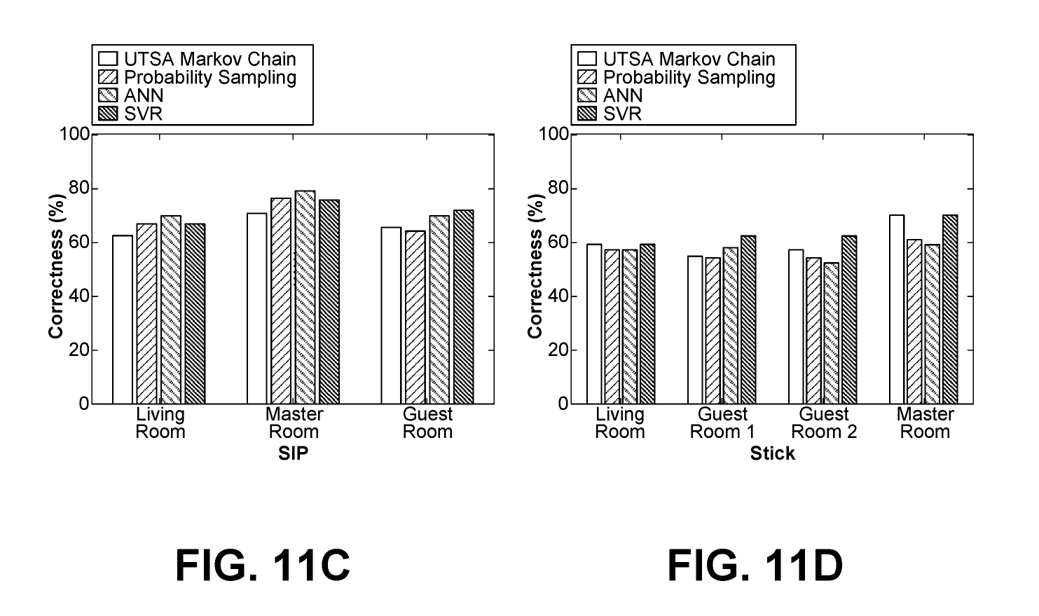

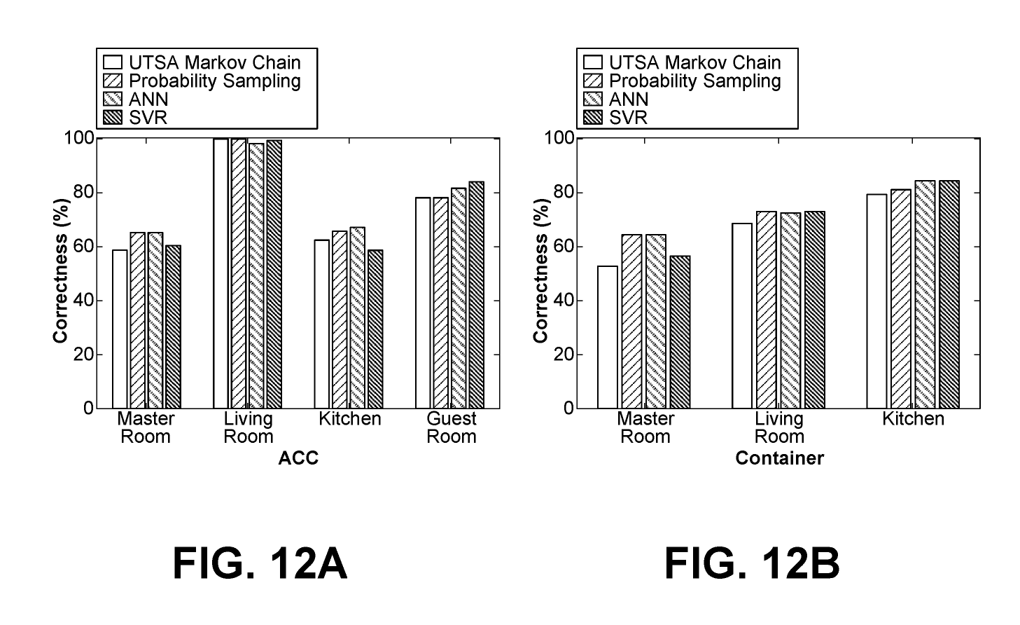

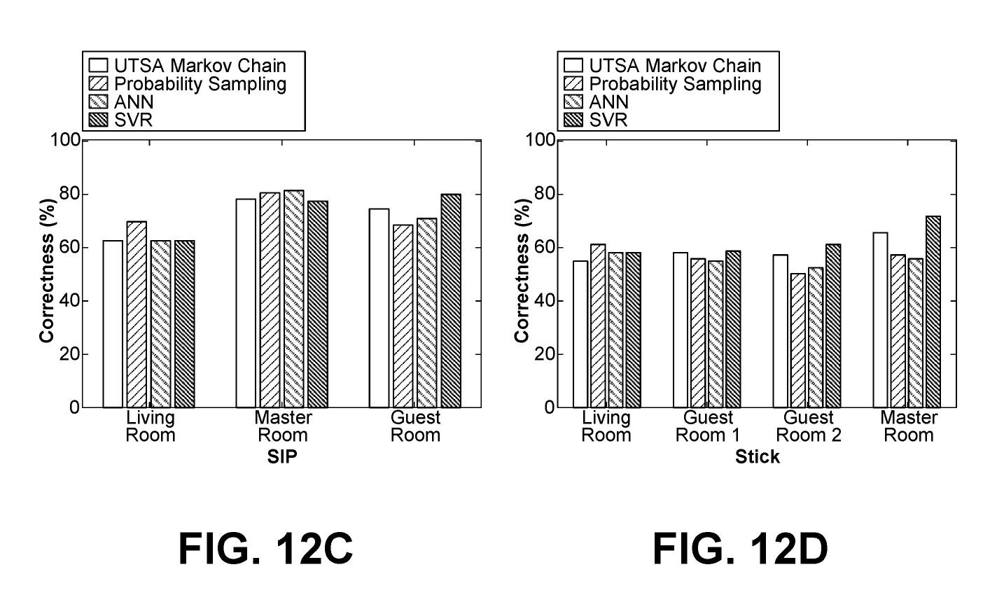

Although similar findings can be claimed for the probability sampling models, the average accuracy for each prediction of the room is much lower than the Markov model. In the contrast, ANN and SVR tend to provide comparable performances and even better in some cases (e.g. the guest room of ACC). For 24-hour ahead predictions, there are no significant differences in terms of accuracy among the all the four models mainly because the methods are predicting based on the assumption that each day's presence pattern should be similar. This kind of assumption could be a drawback for the more stochastic sample among the rooms of the four residential houses. Only a few exceptions existed in FIGS. 11A-D and FIGS. 12A-D where they have more than 75% correct predations.

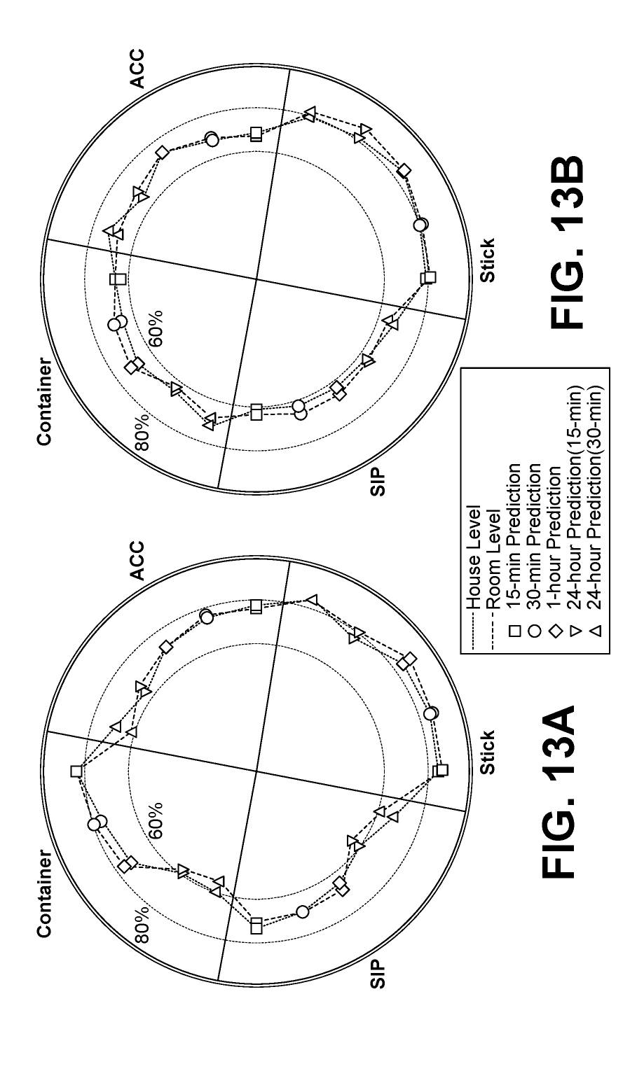

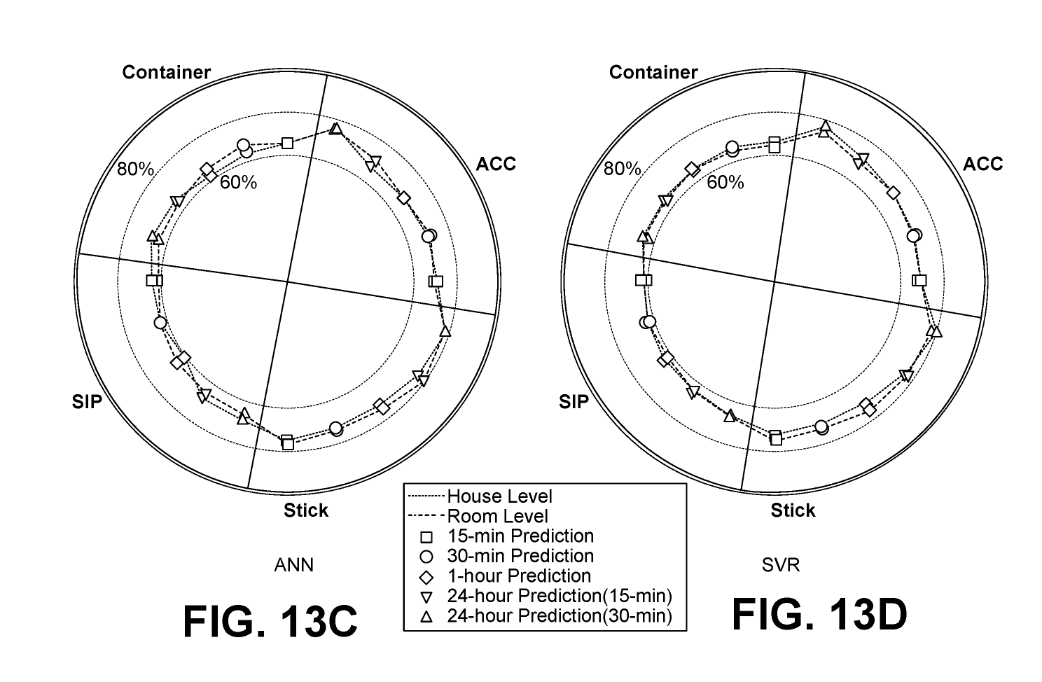

The performances of the models at house level is more important for applications such as smart control of thermostat. In general, occupancy presence can be predicted and derived in two ways: 1) aggregates the room-level predictions to generate the prediction for the house-level and 2) processes the data to a house-level first and then directly predict the occupancy status. The results of the two ways are presented in FIGS. 13A-D for all the samples. Regardless of different methods, forecasting for individual houses does not have many differences in terms of the room level and the house level. The blue lines (the house level) and the red lines (the room level) are similar in terms of accuracy. However, individual houses do have different predictive performances although they are bounded within 60-80% correctness (two circles bounded the blue and red lines in FIGS. 13A-D).

The probability sampling model is improving, which could be explained by the few noises in the house level pattern compare to the room level predictions. Meanwhile, the Markov model is still expected to have a promising performance from 15-min to 1-hour forecast (the square, the round and the diamond shape labels in FIGS. 13A-D). From FIGS. 6A-D, the samples can be categorized as four different types: the single-square shape (ACC), the single-valley shape (Container), the twin-valley shape (SIP) and the flat shape (Stick). By ranking the overall accuracy of the individual house's predictions from FIGS. 13A-D (the red and blue dashed lines), it can also be concluded that the shape of the presence rate (FIGS. 6A-D) does not necessarily correlated to the predictive power of the models (FIGS. 13A-D). The best predicted case is Stick house, where most predictions are larger than 80% accuracy (the blue and red dashed curves at all the lower right quarters of each error polar plot in FIGS. 13A-D).

The case compared to Stick with a similar mean and variance (50%-90% in FIGS. 6A-D) is SIP but it cannot outperform Container which has more variety (20%-100% in FIGS. 6A-D). In general, results from a Markov process model are similar to the probability sampling. However, there are larger accuracy differences seen in the Container sample. By comparing the accuracy curves (the blue and red dashed lines) in the left-upper quarter of the polar plots of FIGS. 13 A and B. In FIG. 13A, the prediction accuracy curves can go near the dashed 80% circle (meaning correctness of 80%), which show accurate predictions made by the proposed Markov model.

A further comparison among the whole shapes of the accuracy curves (blue and red dashed lines) of FIGS. 13B-D can conclude the more similar performances for all samples forecasted by probability sampling through Artificial Neural Network and Support Vector Regression. The probability sampling and the machine learning approaches can be quite stable regardless of the forecasting windows, as shown in the more rounded and smoothed closed curves in FIGS. 13B-D in comparison to FIG. 13A. However, the total area of the closed curves (both blue and red) in FIGS. 13B-D for the other approaches are quite smaller compared to the proposed Markov chain, as shown by the irregular but bigger closed curve in FIG. 13A. This indicates better performances of the proposed Markov process again. However, ANN and SVR perform slightly better in 24-hour ahead cases by checking the specific accuracy symbols for 24-hour ahead forecast, shown as the triangle labels in FIGS. 13A-D. Day-ahead analyses are provided based on two different time step resolutions (15-min and 1-hour). ANN and SVR are the preferred intervals due to weather, electricity price, and load forecasting in predictive control design, which is integrated with occupancy models.

In conclusion, for short term forecasts between 15-min to 1-hour ahead, the Markov model is recommended, while the machine learning approaches are suggested only for 24-hour ahead forecasts. The probability sampling model needs further improvement to escalate the performance. The house-level modeling is more convenient compared to the room-level modelling, especially since there are not many differences between the accuracies for all the four methods in different spatial resolution forecasts as shown in FIGS. 13A-D. The room-level modeling not only processes more samples (each room occupancy), but also presents more stochastic patterns (FIGS. 5A-D comparing to FIGS. 6A-D).

An individual occupancy profile at building level can be derived from the national survey and used for single houses. However, studies based on such data represent an averaged stochastic pattern because Time Use Survey (TUS) data are usually reported in terms of the average time used for various activities by average occupants in a specific socio-economic groups of the population. In addition, most models used in such studies solely depend on a standard Markov modeling process that integrates with the Monte Carlo technique or Cross Validation to enhance the performances. The practical applications in residential buildings require a more robust short term prediction (up to day-ahead).

Real-time measured data can be used to develop the method discussed herein to predict occupancy presence in residential buildings. Advantages of the model discussed herein compared to other approaches are: 1) more accurate forecasting for one-time step ahead (up to 1 hour) prediction of occupancy presence, 2) better comparisons between the current-state-of-the art day-ahead occupancy presence modelling systems, and 3) the ability to adapt to the large variances of the occupancy presence pattern in both the room level and the house level.

The results of various prediction performances for each residential house stem from the fact that every occupant in a house is fundamentally different. Although a single method could not be the best among all models (FIGS. 13A-D), one popular model commonly used for an office environment, probability sampling, presents difficulties to adapt to diverse occupancies at the room level (FIGS. 8A-D to FIGS. 12A-D). As shown, the main advantage of adopting the probability sampling model is not accuracy, but rather easy integration with other models for human-building interaction simulations. For example, the probability sampling built for occupancy models can be represented as a linear relationship between the operation actions (e.g. turning on the light) and the occupancy status (e.g. the first arrival and the active intermediate presence).

Another issue is the expected accuracy for occupancy behavior prediction used for different applications. The performance evaluation of the occupancy models for building energy simulation is different than ones for building controls. The model accuracies from predictions rather than estimations are at best individually claimed and verified for finite samples. By far, there are several potential performance matrixes to measure the predictive power of the occupancy models for office occupants, including: the first arrival error, last departure error, occupancy state one-to-one matching error, number of transitions error, duration of the intermediate presence, and duration of the intermediate absence. However, adopting those criteria is unlikely for the residential samples. Therefore, only one of the errors mentioned above, the occupancy state one-to-one matching error, is used when dealing with residential occupancy prediction.

The temporal difference of the forecast window for the occupancy presence in real-time application should also be considered. In other research domains, the accuracy of the models' predictions could be improved by changing the window of the forecast. A more recent study to predict the occupancy level of the office workers came to a similar conclusion. However, in residential occupancy prediction, no significant changes of prediction accuracies were observed for most samples when the prediction horizon increases from 15-min to 24-hour ahead. For smart buildings, the temporal changes of the occupancy models actually have less influence on a smart controller such as Nest. Those advanced interfaces not only record occupancy presence and human-building interactions from sensors, but also analyze the preference of occupants. This advanced control strategy diminishes the stochasticity of user overrides and increase the predictive power of the occupancy models; although, an even higher resolution of the occupancy monitoring, such as a one-minute interval, could be used to try to improve model performance in the smart control environment. The control algorithms will instead have a more frequent track to the occupancy model. Such frequent responses from occupancy-based controller can highly violate the operations of the systems. Unless the occupants are extremely insensitive to the comfort changes, the predictive performances and control difficulties should be equally addressed in a relaxed forecast window, namely a 15-min, or even hourly scale.

An approach is shown for residential occupancy presence forecasting. By predicting future occupancy presence of different time scales (15-min to 24-hour ahead), the proposed Markov model demonstrates its predictive power specifically for the purpose of control application. The results can be validated through long term measured data from the field tests of the residential houses and compared to other commonly used models for occupancy presence predictions, such as probability sampling, Artificial Neural Network, and Support Vector Regression. The final results show that the proposed Markov model outperforms the other methods in terms of an average 5% correctness with 11% maximum difference in a one-time step ahead forecast, especially with large variances found for the occupancy presence of the tested samples. In day-ahead prediction, not much difference could be observed among the models. Implementing such an occupancy model will be a solution for characterizing the large dynamics existing in the real-time energy consumption and help the building to optimally integrate to the electricity grid operations. It is beneficial for advanced building control if more accurate forecasts can be made for longer windows of occupancy presence.

A significant lower performance in 24-hour ahead prediction scenario can be observed in comparison to the other prediction windows (e.g. 15-min to 1-hour ahead). It is challenging to improve the forecast accuracy in this case even with the changes of temporal resolution (sampling rate) between 15-min and 1-hour resolution. But the results show competitive performances compared to other methods studied. Another limitation related to the proposed model is the computational cost, which integrates a change point analysis looping all the data in the moving window. The optimization could take longer as data patterns become more stochastic. The situation may become worse if longer training data is used. However, if the shortest window of the model predictive control is around 15-min, the systems and methods discussed herein can be used, for example, in online applications by making several trade-offs like increasing the forgetting factor during training process.

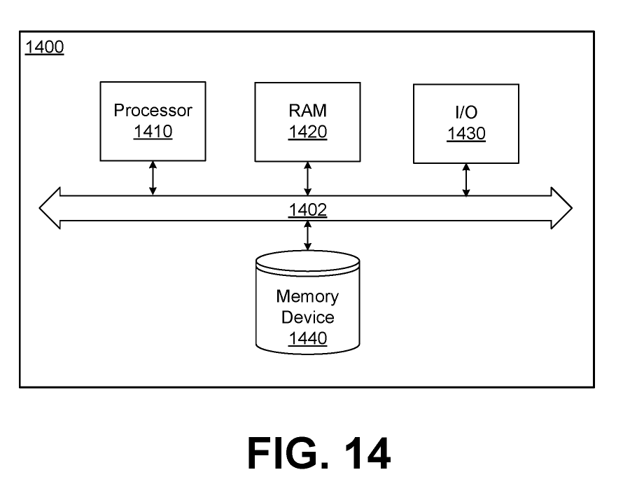

Turning to FIG. 14, an example hardware diagram of a general purpose computer 1400 is illustrated. Any of the systems discussed herein may be implemented, in part, using one or more elements of the general purpose computer 1400. The computer 1400 includes a processor 1410, a Random Access Memory (“RAM”) 1420, a Read Only Memory (“ROM”) 1430, a memory device 1440, a network interface 1450, and an Input Output (“I/O”) interface 1460. The elements of the computer 1400 are communicatively coupled via a bus 1402.

The processor 1410 comprises a well-known general purpose arithmetic processor or Application Specific Integrated Circuit (“ASIC”). The RAM and ROM 1420 and 1430 comprise a well-known random access or read only memory device that stores computer-readable instructions to be executed by the processor 1410. The memory device 1430 stores computer-readable instructions thereon that, when executed by the processor 1410, direct the processor 1410 to execute various aspects of the present disclosure described herein. When the processor 1410 comprises an ASIC, the processes described herein may be executed by the ASIC according to an embedded circuitry design of the ASIC, by firmware of the ASIC, or both an embedded circuitry design and firmware of the ASIC. As a non-limiting example group, the memory device 1430 comprises one or more of an optical disc, a magnetic disc, a semiconductor memory (i.e., a semiconductor, floating gate, or similar flash based memory), a magnetic tape memory, a removable memory, combinations thereof, or any other known memory means for storing computer-readable instructions. The network interface 1450 comprises hardware interfaces to communicate over data networks. The I/O interface 1460 comprises device input and output interfaces such as keyboard, pointing device, display, communication, and other interfaces. The bus 1402 electrically and communicatively couples the processor 1410, the RAM 1420, the ROM 1430, the memory device 1440, the network interface 1450, and the I/O interface 1460 so that data and instructions may be communicated among them.

In operation, the processor 1410 is configured to retrieve computer-readable instructions stored on the memory device 1440, the RAM 1420, the ROM 1430, or another storage means, and copy the computer-readable instructions to the RAM 1420 or the ROM 1430 for execution, for example. The processor 1410 is further configured to execute the computer-readable instructions to implement various aspects and features of the present disclosure. For example, the processor 1410 may be adapted and configured to execute the processes described above including the processes described as being performed by the modules of the ranking and optimizing front end 1400. Also, the memory device 1440 may store the data stored in a database.

A phrase, such as “at least one of X, Y, or Z,” unless specifically stated otherwise, is to be understood with the context as used in general to present that an item, term, etc., can be either X, Y, or Z, or any combination thereof (e.g., X, Y, and/or Z). Similarly, “at least one of X, Y, and Z,” unless specifically stated otherwise, is to be understood to present that an item, term, etc., can be either X, Y, and Z, or any combination thereof (e.g., X, Y, and/or Z). Thus, as used herein, such phrases are not generally intended to, and should not, imply that certain embodiments require at least one of either X, Y, or Z to be present, but not, for example, one X and one Y. Further, such phrases should not imply that certain embodiments require each of at least one of X, at least one of Y, and at least one of Z to be present.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present disclosure defined in the following claims, the scope of which are to be accorded the broadest interpretation so as to encompass modifications and equivalent structures.

Therefore, at least the following is claimed:

1. A system comprising:
a data store; and
at least one computing device in communication with the data store, the at least one computing device being configured to at least:
obtain a plurality of measurements of occupancy of a space;
perform a change point detection based at least in part on the plurality of measurements; and
predict an occupancy of the space for an interval based at least in part on the change point detection.

2. The system of claim 1, wherein the change point detection comprises checking at which time step in a daily profile that an occupancy presence distribution is changed.

3. The system of claim 1, further comprising at least one passive infrared sensor, wherein the plurality of measurements of occupancy of the space are obtained from the at least one passive infrared sensor.

4. The system of claim 1, wherein the at least one computing device is further configured to at least predict a number of occupants of the space for the interval based at least in part on a statistical model.

5. The system of claim 4, wherein the occupancy of the space is predicted based further at least in part on the number of occupants predicted for the interval.

6. The system of claim 4, wherein the statistical model comprises at least one of: a probability sampling, an artificial neural network, a support vector regression, or a Markov model.

7. The system of claim 1, wherein the interval comprises at least one of: 15 minutes ahead, 30 minutes ahead, 1 hour ahead, and 24 hours ahead.

8. The system of claim 1, wherein the space comprises a plurality of rooms and the plurality of measurements of occupancy of the space comprises a plurality of room measurements for each of the plurality of rooms.

9. A method comprising:
obtaining, via at least one computing device, a plurality of measurements of occupancy of a space;
performing, via the at least one computing device, a change point detection based at least in part on the plurality of measurements; and
predicting, via the at least one computing device, an occupancy of the space for an interval based at least in part on the change point detection.

10. The method of claim 9, wherein the change point detection comprises checking at which time step in a daily profile that an occupancy presence distribution is changed.

11. The method of claim 9, wherein the occupancy is predicted based at least in part on a statistical model.

12. The method of claim 11, wherein the statistical model comprises at least one of a probability sampling, an artificial neural network, a support vector regression, or a Markov model.

13. The method of claim 9, further comprising at least one passive infrared sensor, wherein the plurality of measurements of occupancy of the space are obtained from the at least one passive infrared sensor.

14. The method of claim 9, wherein predicting the occupancy of a room, the space comprises a prediction of a number of people in the house.

15. The method of claim 9, wherein the interval comprises at least one of 15 minutes ahead, 30 minutes ahead, 1 hour ahead, or 24 hours ahead.

16. The method of claim 9, wherein the space comprises a plurality of rooms and the plurality of measurements of occupancy of the space comprises a plurality of room measurements for each of the plurality of rooms.

17. A non-transitory computer-readable medium embodying a program that, when executed by at least one computing device, causes the at least one computing device to at least:
obtain a plurality of measurements of occupancy of a space;
perform a change point detection based at least in part on the plurality of measurements; and
predict an occupancy of the space for an interval based at least in part on the change point detection.

18. The non-transitory computer-readable medium of claim 17, wherein the change point detection comprises checking at which time step in a daily profile that an occupancy presence distribution is changed.

19. The non-transitory computer-readable medium of claim 17, wherein the program further causes the at least one computing device to at least predict a number of occupants of the space for the interval based at least in part on a statistical model.

20. The non-transitory computer-readable medium of claim 17, wherein the occupancy of the space is predicted based further at least in part on a number of occupants predicted for the interval.
